(19) United States
(12) Patent Application Publication
(10) Pub. No.: US 2023/0114824 A1
(43) Pub. Date: Apr. 13, 2023

(54) System and Method for Mobile Device Interacting with Multiple Telephone Lines

(71) Applicant: Medial Axis Inc., Marietta, GA (US)

(72) Inventors: Michael A. LeBrun, Marietta, GA (US); James Kyle Bell, Livingston, TX (US)

(21) Appl. No.: 17/965,170

(22) Filed: Oct. 13, 2022

Related U.S. Application Data
(60) Provisional application No. 63/255,113, filed on Oct. 13, 2021.

(51) Int. Cl. H04W 76/10; H04M 3/428

(52) U.S. Cl. CPC H04W 76/10; H04M 3/428

(57) ABSTRACT

A system and method are described in which a server acts as a virtual PBX (private branch exchange) to facilitate telephonic communication. The system and method display all incoming calls to end users’ personal devices. The system and method permit any end user to receive an incoming call, to place it on hold, to transfer it, or to interact with it in any other manner. The system and method permit the easy transfer of incoming calls to the correct recipient or into a voice mail box or a waiting area.

### CROSS-REFERENCE TO RELATED APPLICATION

This application claims priority to U.S. Provisional Application No. 63/255,113 entitled “Multiple Telephonic Line Appearances, Uses, and Control Across Multiple Grouped Mobile Devices” filed Oct. 13, 2021, the entirety of which is incorporated by reference herein.

### BACKGROUND OF THE INVENTION

The present invention relates to systems and methods for a mobile device interacting with multiple telephone lines.

Current private telephone systems for small businesses are configured to provide direct contact between two individuals: an external caller and a single person at the business. Key telephone systems (KTS) in the past provided a business with the ability to have external callers call in to a business and have all those receiving calls at the business see and respond to the incoming call. This allowed all the employees of the business to take, screen, or transfer incoming calls, as needed. Current virtual switching systems lack this capability.

What problem is being solved by this disclosure? Small and medium businesses (SMBs) have been well served by KTS for decades. That all went away with cloud service which is totally Private Branch Exchange (PBX)-oriented - each end user has their own extension, an island with a population of one. This disclosure takes what was great about “business as a community” and reimagines it using modern technology: a KTS equivalent on a mobile device - the perfect balance of tech and practicality.

Accordingly, a need arises for techniques that allow modern mobile phones or portable devices the functionality of a key telephone system.

### SUMMARY OF THE INVENTION

Aspects of the disclosure relate to systems and methods for displaying requests for telephonic communication on a personal user device or a plurality of user devices. The system and method may comprise a server, which may act as a private branch exchange (PBX). The server may communicate with a personal user device or with a plurality of personal user devices through a communication network. Software code residing on the server may enable a method. The method may comprise receipt of an initial request for telephonic communication, such as from a device external to the system. The initial request for telephonic communication may be received by the server. The personal user device may receive a notification from the sever of the initial request for telephonic communication. Upon a user-initiated request, the server may connect the device associated with the request for telephonic communication with the personal user device.

The system or method may further comprise information associated with a device which is the origin of the initial request as part of the notification. The method may further comprise placing the initial request in a waiting queue. The method may further comprise transferring the initial request to a second user for connection. The method may further comprise at least one additional request for telephonic communication and all the requests are displayed on the personal user device. The method may further comprise merging or combining the incoming call so that two or more users may interact with the incoming call.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates the application software interactions

FIG. 2 illustrates a telephone call presentation

FIG. 3 illustrates an API/CTI call presentation

FIG. 4 illustrates a screenshot of a device application with multiple incoming calls.

FIG. 5 illustrates a telephone redirect call.

FIG. 6 illustrates an API/CTI call answer.

FIG. 7 illustrates a screenshot of a device application with call on hold.

FIG. 8 illustrates an API/CTI redirect call.

FIG. 9 illustrates an API/CTI transfer call

FIG. 10 illustrates a screen shot of an incoming call on a tablet.

FIG. 11 illustrates a screen shot of an incoming call on a mobile phone.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

Prior art references such as U.S. Pat. Application 2015/0133133 A1 - “Provisioning Interfaces for Accessing Virtual Private Branch Exchange Services Through a Mobile Device” and U.S. Pat. Application 2011/0281580 A1 - “Mobile Phone Integration with a Private Branch Exchange in a Distributed Telephony System” discuss aspects of virtual switches interacting with a mobile phone.

Both inventions ‘133 and ‘580 conceived of the mobile device as an endpoint for a PBX. The titles to their patents alone suggest that. Thus, both of these patent applications are attempts to allow a mobile device (e.g., a cell phone) to act with the functionality of a private branch exchange’s (PBX’s) typical business phone (primarily a desk-top phone) in its approach to processing calls. The (desk-top) phone rings, it gets answered, and if the caller wishes to speak to others, the user can transfer a call using the PBX feature to do that. Such a transfer usually requires entering a dial code or a button on the device that actually dials that code for the user. Additionally, other PBX functionality may also be extended to a mobile phone in communication with the PBX, but actually separate and apart from the PBX itself. In the ‘133 and ‘580 applications, and likely also in other related inventions, a mobile device may be incorporated into a PBX. The problem with using a PBX is that most PBXs connect to each user’s mobile device independently of all other users’ mobile devices. These devices may be linked to the common switch via a common communication thread - the PBX extension number—but do not otherwise interact with each other. Most PBX solutions treat each mobile device as an end to the communication link rather than as one part of multiple people who should be notified when a call is directed to the business.

In this disclosure, the concept to emulate is not a PBX, but a key telephone system (KTS). In a KTS, all user phones may receive all incoming lines or calls, which is often called a squared system. Thus, the users may become, in many ways, interchangeable parts of the success of the enterprise - many individuals but one purpose. The small and medium-sized business (SMB) worker is not on an island, but instead is part of a community. This disclosure imagines that users are interconnected not just by fine PBX threads, but by the necessity of multi-tasking and the common goal of business success. For example, this disclosure may allow anyone end user to answer an incoming call to, say, a business. The end user may verbally transfer any call and then have a free interface with the caller and may need to go back and forth and back again. This technological and personal interaction provides a customer experience of warmth that is characteristic of a KTS instead of the calculated cool efficiency of a PBX.

There is a difference between ‘133, ‘580, and this disclosure in its programming of the cloud PBX, the functionality of the mobile app itself, and as described, how the user interacts with the caller. In many ways, the difference between ‘133, ‘580 (and other similar patents or patent application) and this disclosure is like commuting by car, a bicycle, and a train - they all get a traveler want the traveler wish to go but the experience is very different.

The present disclosure is concept and application: (a) the approach to how a user interacts with the media and how a typical small to medium sized office operates; and (b) the appropriate utilization of purpose-built technology to fulfill the Theory of Business Operations as Community.

The purpose of the invention is to reimagine a traditional and effective SMB communication system, the KTS, and apply that system’s simplicity, ease of use, and purpose-suitableness to a modern telecommunication infrastructure and products. This disclosure conceptualizes multiple telephone lines appearing on a user mobile device and being able to be utilized on that device. In addition, such line appearances are shared with and have a commonality among multiple devices. In summary, this disclosure describes a KTS on a mobile device.

The inventors are asserting that they have created the concept of displaying multiple lines/multiple users on mobile devices and the utility of how that can be accomplished.

Several options are available for implementing this method and system. In embodiments, these may include hardware centric, hybrid, and software centric solutions.

Hardware Centric: A traditional on-site PBX that is programmed to allow mobile devices as endpoint extensions. The traditional on premises PBX may treat these endpoints as agents in a call group and may accept commands from the mobile device application. Mobile devices (and computer softphones that are emulating a mobile device functionality) may run software APIs that interface with the PBX. The traditional PBX may be ordered to achieve a particular functionality. It may also provide an easy user interface with the central switch as well as with other users. Such a hardware centric approach may have software that allows multiple line appearances without regard to the limitations of the end user devices and the network. This may enable a typical cell phone to overcome the traditional single talk path to have multiple incoming calls routed to it.

Hybrid Methodology: This uses a PBX, whether traditional purpose-built hardware or a server that is running PBX software, that is physically distant from the user premises. This physical separation may be considered (or called) remote, co-located, virtual, “cloud,” or other names. Except for the lack of on-premises switching hardware, the Hybrid approach as to functionality may be consistent with that in Hardware Centric description.

In both the On Premise Hardware Centric and Hybrid Methodology it may require a significant amount of work to set up the software on the mobile device. The mobile device may perform features and maintain the feature functionality of this disclosure. In this instance, the mobile device may be required to be configured to interact with the PBX and the PBX represents fairly standard functionality.

Virtual Infrastructure and Thin Client Architecture [“VITCA”]: This architecture utilizes software programming to emulate much of the same PBX abilities present in the Premise Hardware Centric and Hybrid Methodology. However, in this instance, the software may be bespoke and written specifically to provide the required PBX functionality without the unnecessary overhead that is typical in a PBX or server running virtual PBX software. The host server to perform the tasks usually associated with the telecommunications switch is provided by either a server that is present on site or remote (most likely in a data center) and can be virtual or non-virtual. VITCA is a web application design, running on a web browser and accessible by any design of mobile device (or softphone for that matter) regardless of operating system. Furthermore, in VITCA, unlike the other methodologies described here, the mobile device only has to be programmed with a “thin” client, i.e., a lightweight program that sets up and maintains a communication path with the server. Here, the server is doing most of the “heavy lifting” needed for this disclosure and the device is communicating with this host for feature functionality.

Consider, this disclosure has three different components: (a) the application on the device; (b) the capabilities of the switch (a PBX) and (c) transport or the way that the handset talks to the switch. In order these elements are:

An exemplary application may be built as a native application utilizing the native OS of the device, for instance an application written for the Android operation system of a mobile phone. The code may ride on the device as part of the software - theoretically not exactly part of the Android OS but yet more than just another app. In many ways, this disclosure acts as “middleware”.

An embodiment may employ an original design using a virtual (cloud) PBX (on a server). For example, the Asterisk platform may be utilized.

The virtual switch may be a typical PBX, but with customized software and reprogrammed. The PBX switch may be modified in such a way that it does not treat the mobile device like a typical endpoint as do most PBXs. Instead, the code may make the PBX treat a mobile device like an agent device that is part of a call group and the device’s programming allowed sharing along the agent extensions and devices.

A switch may be modified while still taking advantage of its inherent programming and interfacing it with device programming with an improved interface. A virtual PBX may send calls to be answered by an agent call group. (An agent call group may be a room full of cubicles functioning as a call center filled with customer service agents.) This disclosure describes not just the utilization of a call group, per se, but that the extensions are line appearances on each and every device. One way to consider this is not to consider the mobile device as an endpoint, rather, the line appearances are “endpoints,” The mobile devices may be logged into the group and ready to take calls just like normal, but all those extensions are appearing as lines on one or more cell phones.

In an embodiment which utilizes a specific virtual PBX (e.g. Asterisk) some particularities may be observed which may not be available on other environments, whether virtual or on premises. In principle, any PBX may be able to anchor this invention. But there is a limitation to this effort in that every manufacturer and indeed, practically every switch is different. While this disclosure comprises all PBX switches, the examples below use Asterisk as the virtual PBX, although other alternatives are readily apparent to those skilled in the art.

In an embodiment, session initiation protocol (SIP) trunk lines may be accessed using a trunk line provider, for instance Bandwidth.com. These trunk lines were chosen to demonstrate the business opportunities which may open up.

### As a NetApp

Changing the architecture of this disclosure to a net application would not really change the customer experience, with the exception that any device could reach the application (instead of just a single operating system), which has huge implications:

In an embodiment, the Android operating system on the device can be the predominant operating system. However, as a net app, this is now a tiny thin client as the code simply establishes communication with the switch, but the additional code and processing takes place remotely on the communications server. The native capabilities of the mobile device’s OS may be incorporated as efficiently as possible.

In this particular configuration, there is no requirement for an explicit PBX. Instead, a server may run communication-oriented software. All of this code may be bespoke - written specifically for this invention. The application may leave out some of the many features that the switch’s code may supply, but which are superfluous (or even overly distracting to) the users.

A typical PBX has perhaps a hundred features or more because additional functions could be added at minimal additional cost. An example of an additional feature is “twinning” a phone. Twinning a phone means that a desk phone and a computer soft phone or a desk phone and a cell phone would all ring at the same time. Speed dialing is another typical feature of PBX systems. These features are supported because PBX sellers have to sell desk phones, although few PBX purchasers actually use these features.

Transport of the actual communication signals may remain basically unchanged but it is even more imperative that a stable data communication capability is maintained. After all, the Internet must be accessed to use the application.

In the network application approach, the application may be accessed from any device. Every time that the operating system (e.g. Android or iOS) is changed or updated the thin client may require a tweak. Such minor tweaks are likely to be minimal and thus easier to support or even easier to initiate. Changes may be made mostly be at the switch level. Troubleshooting will be much easier, as the switch is 90% of the service in the net app as opposed to 35% with the hybrid or hard-ware centric approaches. Thus the network application is easier to adapt, easier to maintain, and less costly than the other approaches.

It has been speculated that any PBX might be tuned to use the mobile device software. In the net app, it will even be easier (or at least different) to interface with whatever switch is utilized by the customer. The net app will not appear as a “foreign” software application to the customer’s PBX. Instead, the software code described in this disclosure may be complimentary to the current configuration.

For decades, business communication was run by a central telephonic junction, commonly referred to as a “switchboard.” In the beginning, a switchboard was equipment that physically connected two points, relying on a human operator to literally “plug” in the connection. This arrangement, with a multitude of wires being plugged into a myriad of peg shaped holes, was referred to as a “cord board.” In the late 1960s and early 1970s, the switchboard eliminated all physical connections with the arrival of the “private branch exchange” (“PBX”). A PBX enabled the human operator to handle calls much more efficiently due to electronic programming.

Since that time, technology has progressed rapidly in telecommunications: the arrival of advanced computing power evident in the Internet Protocol (IP) PBX, upgrades in communication media like fiber optic cable, and “virtualization” of the traditional switchboard. Slowly, the human operator evolved out of telephony.

Corresponding with this business communication development was the cellular phone. These mobile devices were at first a rarity. Now, 97% of people in the US have a cell phone. It goes without saying that telecommunication is everywhere.

While technological development is typically favorable, such is not always true. In telecom, businesses that never needed PBX-functionality have seen their needs ignored. Traditionally, SMBs did not use a PBX. Instead, they used something called a key telephone system or “KTS”. A KTS owed its usefulness to simple utility - each telephone line was located on a button on the phone. When someone called the business, the phones rang, the corresponding light blinked, and a member of the business staff answered by pushing the button. The user could put the caller on hold. Or they could have someone else pick up the call by either actually (physically) telling them (“Hey Billy, pick up Line 2”), or by using an intercom that was built into the KTS (“Ms. Jameson, Mr. Hinds is on Line 1”). KTS was easy to use and worked. It wasn’t perfect but what it lacked in feature functionality it excelled in simplicity.

More importantly, a KTS perfectly fit businesses that required “community-thought” in order to function. In SMBs, employees may have a job title and a responsibility, but they wear many hats. For the most part, the employees are interchangeable. What restaurant hasn’t had the manager bus tables, what doctor’s office hasn’t had the physician look over the bookkeeping, the hotelier who delivers extra towels to a guest, and the lawyer who greets a potential client who walks in the door? This is how many businesses operate - all employees performing all the tasks required to get the work done. The KTS model fosters this community of enterprise with a common purpose by maximizing the transposable human assets.

Yet, in many ways, telephony moved away from this ideal. Technology arrived and KTS wasn’t good enough anymore. Instead, now virtual PBXs lend extension numbers to all, which optimizes technology but not people. Furthermore, mobile phones are ubiquitous, now in every pocket. Communication may appear simpler through a mobile phone, but it may instead isolate people all the more.

In addition, the technological challenge with mobile phones is they have one call path and can handle only one call at a time. It’s like looking through the world through a long tube - you can only see what is in front of you.

So, what if there was a way to harness technology while fostering community? The technology would incorporate the ubiquity of the mobile phone, the advanced technology of the cloud computer telephone exchange, and the simplicity and community-view of KTS. In essence, a mobile and virtual KTS.

This solution includes software for a mobile device and specialized programming of a virtual telephone switch. Importantly, the invention is more than a product and service, software and hardware. The invention allows a better way to use technology to maximize human assets. To that end, this disclosure describes a virtual KTS construct that can be utilized via a computer softphone or mobile phone.

The invention allows any businessperson to have multiple line appearances on their mobile device or softphone, much like the KTS of old. In addition, advanced call control is lent to the invented communication solution by a cloud telecommunication server which is tuned to perform like a KTS controller.

Every PBX has call groups which are used in call centers the world over. Call center agents log in to the group and the switch lines up calls for them to take. In this disclosure, this same capability same is used to turn all the employees at the SMB into an agent. Thus, when for example, an employee log on to this system, the worker is effectively telling outsiders “I’m an agent and I can take a call.” Then when a call comes in, the user may press the appropriate button to receive an incoming call. This action commands the switch to connect the incoming call to the user’s phone.

Putting a call on hold may use the “call park” feature of a switch. The call park feature allows anyone else to also pick up the call which is not possible on typical system using the hold feature which does not enable a user-friendly call transfer. With this system, a second user, who may be told across the cubicle or desk “Hey John, your wife is on line 2” actually pushes the held call button. By pushing the line 2 button, the second user instructs the switch to connect the call currently parked in position 2 to that user’s phone.

This gives any cell phone or specialized softphone user a full-functioning telecommunication system, with tremendous ease of use inherent in KTS, in their pocket or hand. Finally, by approximating and recreating a modernized KTS, the invention advances the community and interfunctionality of personnel intrinsic to small and medium businesses. What is delivered is an experience that is not only technologically efficient but also personally effective.

This disclosure addresses the telecommunication needs of small and medium sized businesses which have been largely left out of telecommunication development revolution.

The invention includes a software application working on a user’s mobile phone that shows multiple telephone line appearances and incorporates the ability to act upon those appearances, including but not limited to, answering calls, placing them on hold, reestablishing connection, “vocal” transfer, “monitored” transfer, “blind” transfer, conference, and other features as well.

A unique or atypical function will be for the system to show not that they are on a call (that is typical PBX — it’s called a BLF — busy lamp field) but also that they are in a Do Not Disturb (or other) mode such as “in a meeting,” “logged out,” “at lunch with client,” or “on vacation.” This function is added so that any user can designate the reason they may be logged out. The system may determine what is meant by the particular logout code that the user has entered. This additional function provides more information than the BLF of a typical PBX, like Microsoft Teams showing only “present” when a person is attending a video conference or a meeting.

This application does not control the call, but instead, creates a mobile framework for the call to be utilized and administered by the user.

Specialized configuration is placed into a modern cloud PBX telephony service which comprises a leverageable feature set that lends call control via an Application Programmable Interface (API) or a Computer Telephony Interface (CTI) act as a traditional telephonic switching component. Here, the cloud server is the “nexus” of the invention, providing (1) a view into telephony activity, (2) access to call control and (3) giving the administrator the ability to (i) combine and divide call flows, (ii) track and manage call traffic, and (iii) change certain call patterns and programming to meet the functionality enabled by the software application.

A cloud server will allow an administrator (e.g. a user or other designee) to build and amend the user agent groups, to measure traffic, and, if necessary, to customize the application to some degree. For example - say a business has customer service and sales departments. Some numbers could be designated for one and not the other (or rather you’d have two different agent groups. The “line appearances” might not be the same for all groups.

Small and medium sized businesses (SMBs) do not work as individuals or as purely functional groups like larger businesses do. In larger enterprises, groups of people work in a functional area (for example, the accounting department). The functional area defines the employee’s purpose and they typically do not stray outside their expertise. In contrast, SMB employees work as interchangeable components of the business at large, “wearing many hats,” and performing myriad functional tasks in order to ensure organizational success. With this realization, the inventors germinated and developed a theory of business operations as community [“BOAC”] to describe how SMBs actually operate. BOAC represents the reality that SMB employees work as integrated and interchangeable parts to the organizational whole. As telecom technology unfolded, telecom providers ignored the practical application of BOAC principles, and instead, providers maximized the number of technological features which do not address the way a SMB actually works. The BOAC foundation of SMB “community-thought and action,” was either undiscovered or ignored. This disclosure helps to maximize the abilities of the personnel at SMBs to interact with others using time-tested techniques and allows each employee to perform multiple functions.

As mentioned elsewhere, this disclosure works with a cloud telephony service which, for the most part, is a typical modern IP-PBX. However, the inventor has taken the step of harnessing the abilities of the cloud-based service to accomplish effects the device normally does not do.

An IP-based PBX can congregate telephone lines into functional units or “call groups.” Typically, call groups are used in a business’s customer support or sales call centers to direct and distribute incoming callers to a group of individuals who work in that particular unit. This service is commonly referred to as Simultaneous Ringing or SimRing which actively sends the calls to the devices for any or all of them to answer interacting directly with the end client via telephony signaling.

For this disclosure, the system may present a list of possible incoming phone calls, all of which are displayed on all the user devices which are part of a call group. In the call group this list of incoming calls may be referred to as a call appearance or a line appearance. Each of these call appearances represents a call the end user may choose to receive. The users are presented with these options via an interface. Each user may inform the cloud telephony service which of these line appearances they wish to receive by, for instance, tapping on the button on a phone displaying that incoming call. Another example would include, for instance, using voice navigation to say “answer the call on line 3” which may direct the system to make a telephone connection between the incoming call on line 3 to the end user’s device.

The call appearances on the users’ devices are displayed in real time as other people call the enterprise. The call appearances may also use codes (e.g. differently colored buttons) to display additional information related to a call. For example, the line appearance may change from one color to another with the color indicating whether the call is incoming, on hold, answered by a first employee, or answered by a second employee. Another example of additional information conveyed by changes in the display of the call appearances is that the button for an incoming call may turn red if the incoming call has been parked or on hold for longer than a certain period of time.

An incoming call may be received by the switch (e.g. a virtual PBX) and may be designated to be sent to an agent group. In the example of a SMB, the agent group may well include every user at the SMB. The system will display on the users’ devices for all the users who belong to the group and who have designated that they can receive incoming calls. The users’ devices may also ring or use some other signals (e.g. flashing lights) to indicate an incoming call. By, for example, tapping on call appearance button for a particular line, the user device is instructing the client software to connect that incoming call to the user’s device. An alternative method of indicating which call to accept include using voice navigation. Once the user has requested to be connected with a particular incoming call, then the switch complies and the user is connected. In an example, if a user wants to put an incoming call on hold or direct an incoming call to a particular user’s voicemail, the user may depress the same button and the user’s device may display a list of options for what to do with that call. An example list of such options comprises: connect incoming call, place call into parking lot/hold, transfer call to a particular user, and end call.

. In an aspect, once this function is performed, only then, will a telephony connection be executed against the device endpoint to deliver the call. This function is the opposite of SimRing in that all devices are alerted to the presence of a call to receive; the devices may not receive calls unless the service is instructed to deliver a particular call in the group by a user.

All mobile phones possess only one functional “path.” Like a single lane highway, this one path equates to only one connection back to the cloud telephone switch (or in the case of cellular service, a connection to the radio transmitter and cell switch). However, this one path contains two simultaneous connections or “channels” - one for call command (for example, dialing and ringing uses this channel) and one for the actual voice conversation. The invention however leverages neither of these paths. Instead, it uses the aforementioned API or CTI interface to exercise call control thereby making the cloud telephony service responsible for telephony endpoint manipulation, not the traditional end telephony client. This approach equalizes the ability to exude call control over different types of endpoints such as a traditional PSTN network-enabled cellular connection or a data supported SIP telephony destination. This approach is agnostic to call delivery methodology and bypasses the traditional means of call control.

Traditionally the features present on the cloud PBX service had to be compliant with a typical client telephony interface and were reliant on the traditional telephony protocols which are implemented under the standards set by outside bodies. This approach provides the opportunity for a sturdy and reliable feature implementation. However, this process is slow, cumbersome and requires entities such as telephony carriers to implement features which enable such protocol changes. For this reason, the PBX vendor market began implementing API and CTI interfaces which extend a feature set beyond the traditional protocol exchange methodology. Since this invention leverages the faster moving API or CTI method of call control, features not available in standard telephony interactions may interact with and extend control into the application software. The invention allows emulation of KTS functionality by:
1) asking the cloud PBX for a list of active calls in a given group, the ability to organize callers into an Agent Calling Queue and treat each endpoint as a Queue Agent,
2) performing software-initiated transfers over client call legs from the switch itself rather than from the telephony client protocol interface, and
3) placing a call in a parking lot or waiting area via a single button push where anyone else in the client group can retrieve the call also with a single button push.

A device which employs these methods can observe and attend to multiple telephone calls at one time. In addition, all of these calls have an “appearance” via the software application running on the device. This aspect comprises the “multiple telephonic line appearances” characteristic of the invention.

Other members of the call group, which are equipped with the invention, will have the same line appearances on their own mobile device and may observe and manipulate the same line appearances. These devices are considered telephonically “squared,” that is, all available telephone lines for the enterprise appear on each person’s device, analogous to the KTS lines which appeared on a standard business telephone set. Through the configuration of the cloud switch and device application, the telephone lines can also be delineated any way the enterprise desires, including but not limited to functional assignment (e.g., sales) or geographical group (e.g., Atlanta office). As an alternative, the functional groups can also be “unsquared” where only some lines appear for particular groups. This is the “multiple grouped mobile devices” characteristic of the invention.

Because the system can be squared, users can exchange active (or held) telephone calls via “verbal transfer” (e.g. verbally telling a colleague in earshot “Jane, call from 3618 is for you”) whereby the addressed user simply presses the corresponding button showing a call from 3618 to take the call. The user might also send the other colleague a text message, or contact them through an intercom, or show them a note to let them know about the incoming caller. This is typical in traditional KTS systems but unknown in the incorporation of mobile devices or PBX extension sets. To achieve similar functionality in the PBX sets, a user must “park” a call in a lot (a waiting queue for incoming calls or calls being transferred), remember the position number of the parked call in the lot and communicate that parking lot number to the new recipient. The new recipient must then dial the lot code from their device, enter the parked call number and retrieve the call. This is a far more cumbersome process fraught with the peril of losing the caller and not remembering the position number. Extending the KTS call pickup functionality to the end user leveraging the PBX parking lot function is a far more natural and reliable means of providing call access to another member of the call group. Of course, that user can also utilize the typical “transfer” feature whereby a call is electronically “sent” to another user, but this is also less friendly than the KTS feature described here.

Having multiple line appearances on each device means that every user can track several conversations at once, switching between calls as needed, which may increase user efficiency and improve the caller experience. The ability to “stack calls” is a commonly found and leveraged business practice for a reception station. Who hasn’t called an office, gotten a receptionist who has greeted you with “hold, please”? The reflexive ability to see an inbound set of calls, answer the first call with a “hold please” and repeating that function through four ringing calls is a vital business practice missing from mobile devices and PBX extension services. Additionally, with these calls stacked, someone else in the call group, an office manager for example, can see all of these calls waiting for attendance and come rescue the receptionist performing the main inbound call handling duty.

Common Mobile Applications. Practically all cloud telephony service companies have a mobile application (“mobile apps”). This is so typical that it is rare if a provider does not offer an application (and even then, it is sometimes possible to download an open-source application on a mobile device and get it to register with the cloud server). Several differences between the present disclosure and these other, common applications include:
a) Mobile apps are one call at a time. The user can process calls to other users via transfer or use a telecommunication bridge to establish a conference call. Thus, mobile apps do not have the ability to have multiple line appearances which may be independently acted upon (which includes going from one call to another to another, directing a particular incoming call to a particular user’s device, or offering the option to leave a message).
b) Mobile apps are limited by unique users, in other words, they cannot have multiple users possessing multiple lines for easy call administration. Mobile apps can only telephonically transfer, but they have no ability to “verbally” transfer a call by placing the inbound call back to the queue and notifying another end user to pick up the call (e.g. “Jane, please pick up call “3618”).
c) Mobile apps are limited by the number of calls that they can process, i.e., one call can be put on a private hold while another call is addressed. This is, in essence, one call at a time processing.
d) Mobile apps cause the device to become a PBX endpoint (the individual “island”) as opposed to the present disclosure’s fostering of the concept of BOAC (SMBs work via community-thought and action).

An Application Programming Interface (API) is used to build a computer-telephony integration (CTI), which really is an API of its own. A PBX performs call observation and control. Our solution does this as well but as described, it will do it in a very different way. Other telephony applications treat a cellular phone like just another PBX endpoint. This system treats each device like an agent in a call group - an endpoint that is not an individual but part of a collective.

The invention leverages API or CTI interface rather than a standard telephony protocol interface for call observation and control. This is the heart of the difference between the instant invention and all other mobile telephony applications which exist today. The following illustrations help demonstrate these differences.

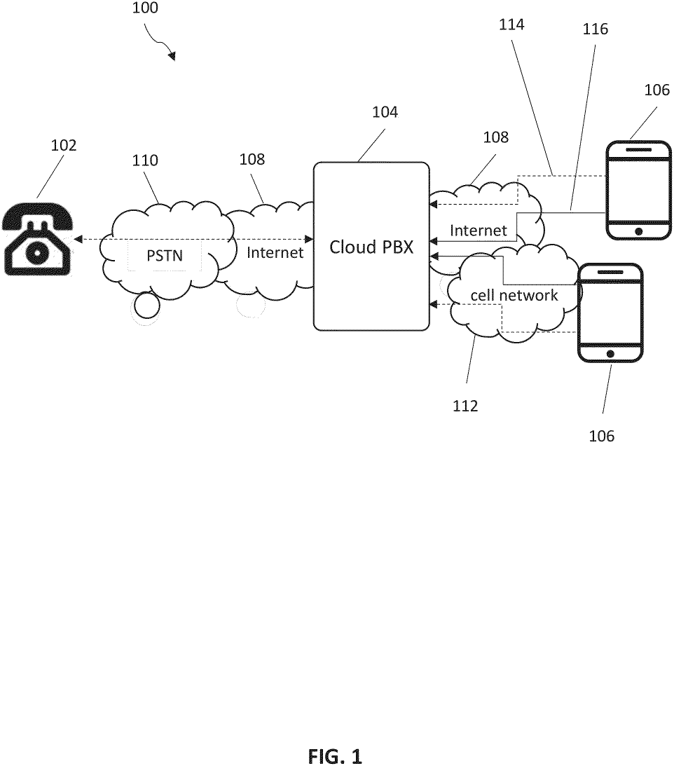

FIG. 1 illustrates the interactions amongst the various components of the system 100. A call from an external phone 102 is placed. This call is routed through a publicly switched telephone network (PTSN) 110 or through the internet 108 to reach a cloud-based private branch exchange (PBX) 104. The cloud PBX 104 routes the call through the internet 108 or through a cellular phone network 112 (or some other network) to connect to several user devices 106. This system 100 makes use of API (application programming interact) interactions 114 or a regular call path 116 or both, as needed.

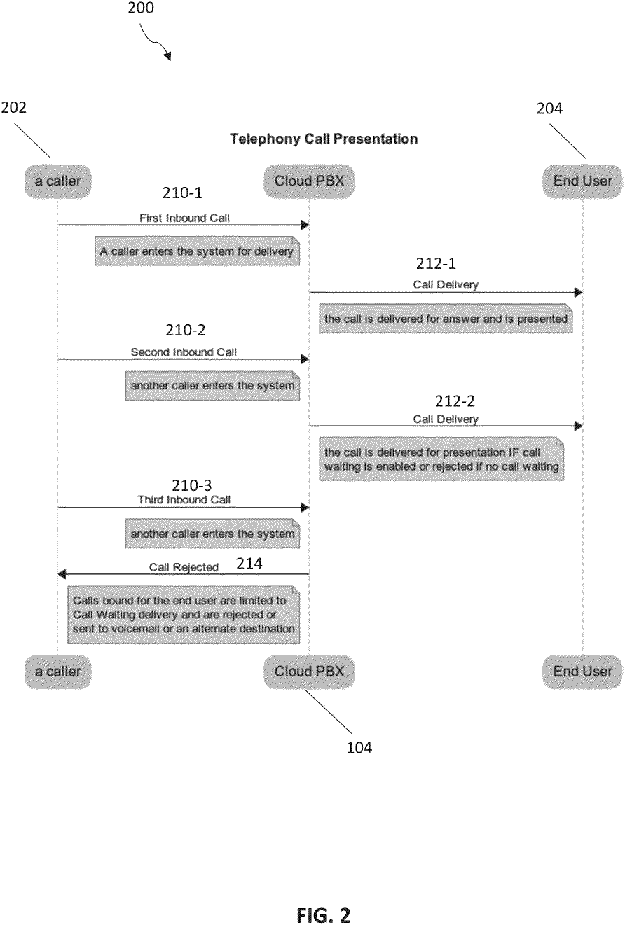

FIG. 2 illustrates how calls are presented to the user via a standard protocol via a standard telephone call presentation system 200. Because each call is an active session representation to the user, the presentation is limited to that active call path. An outside caller 202 places a call 210 which is received by a cloud PBX 104. 210-1, 210-2, 210-3, etc. represent a first, second, third, etc. inbound call. At 210-1 the first inbound call is received by the PBX. At step 212-1, the first inbound call is routed to an ender user 204 or is delivered. This call delivery 212 may also have a first delivery 212-1, a second call delivery 212-2, etc. A second inbound call 210-2 may be placed, be received by the cloud PBX and delivered to an end user 204 at step 212-2. In another example, a third inbound call 210-2 is received by the cloud PBX 104, but is rejected at step 214. Calls bound for the end user 204 are limited to call waiting, re-direction to voicemail, re-direction to an alternate destination, or rejected.

In this disclosure, a slate of calls for a user group is merely being queried rather than a call session being established. The application software has the opportunity to present an infinite number of call state representations or line appearances to an end user. This function offers the user the ability to decide how and when they will receive or interact with an active call session

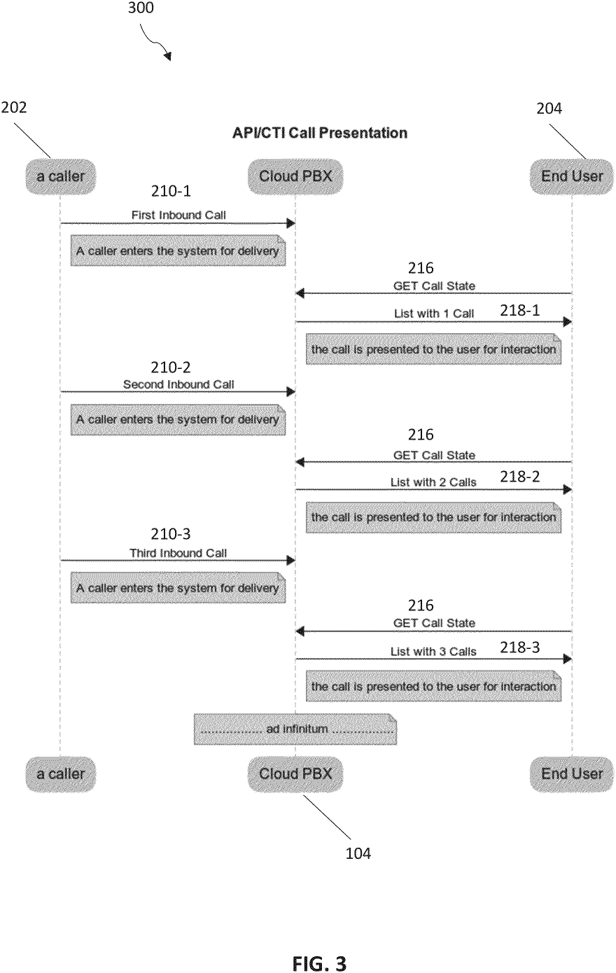

FIG. 3 illustrates how calls may be received by the destination client in the present disclosure via an API/CTI call presentation system 300. A caller 202 calls an end user 204. A first inbound call 210-1 is received by the cloud PBX 104. An end user (or an end user device) 204 may query the cloud PBX 104, perhaps on some regular schedule (e.g. once per second, or once every 10 seconds, or some other schedule) for a list of incoming calls 210. In this instance, the cloud PBX 104 may respond to the query 216, with a list of available incoming calls 218 (e.g. first call 218-1, second call 218-2, third call 218-3, etc.). Rather than the first inbound call 210-1 just being answered by the end user 204, the inbound calls 210 sits at the Cloud PBX 104 waiting on an end user 204 to signal reception. The end user 204 sees the interaction opportunity and chooses to receive whichever inbound call (210-1, 210-2, 210-3, etc.) and then that selected call is directed to their destination client. Thus an end user 204 may choose to prioritize a particular incoming call over others, perhaps because that call represents a particularly important client, or a client requiring particularly time sensitive response, or other reasons (e.g. geographic proximity, timeliness, customer prioritization, or other pre-determined business rule). During an initial set-up of the system, an enterprise administrator could inform the system of priorities or notifications associated with certain phone numbers to allow end users to prioritize certain calls, if needed. For example, in a call center the PBX can shepherd calls from larger customers ahead of calls from smaller customers to the agents in the call group. The system may also be configured to block certain numbers, such as phone numbers associated with unwanted solicitations. The system may present an incoming call 210 to an end user 204 including information associated with a particular phone number, such as the number itself, caller ID, geographic location, or other information associated with an incoming call 210 in order to assist the end user 204 in evaluating a priority for answering a call 210 or in evaluating the best person to answer the call 210. In an example, if a business has an important customer who has just purchased a complicated system, incoming calls from that customer may appear on every device of the call group, but appear in red on the device of the technical support specialist.

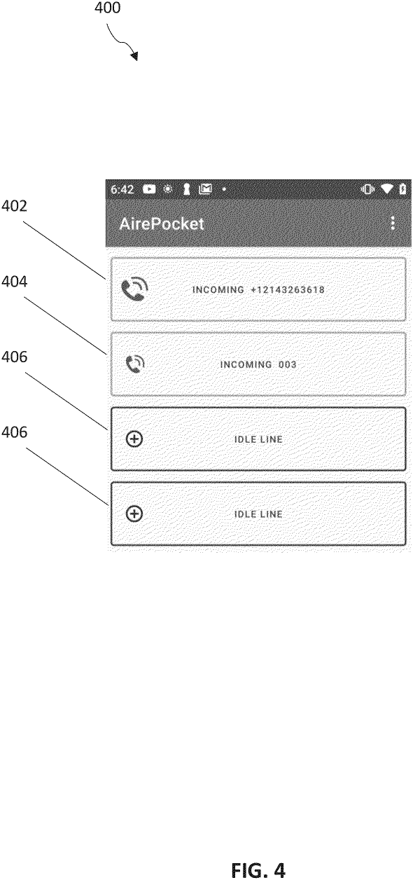

FIG. 4 illustrates an exemplary screenshot of the application. Here the screenshot 400 displays a first incoming call 402 identified by the incoming caller’s number. The application 400 also displays a second incoming call 404, identified by the line number of the internal phone system director, or other indicator. The application also displays two idle lines 406, which are open to having yet further incoming or outgoing calls. Note that this display may appear on the mobile device of several users, so that each user can identify which lines are in operation, an identifier of the caller, and an identifier of who has received the call. The number of incoming calls and the number of idle lines can vary dependent on various settings, including those based upon assigned groups, individual settings, or other settings. In an example, every person at a business can be an agent of the main call group and all have identical call appearances on their own devices. In another example, the system may have designated subgroups that don’t share call appearances with the main call group (e.g. tech support calls appear red on the tech support sub-group devices, but gray on everyone else’s devices). In another example, the sub-group may receive certain incoming calls, and these calls may not even appear on the devices of those not in the sub-group. Even though the numbers wouldn’t appear on every phone in this configuration, the recipients (e.g. any member of the sub-group) could still extend calls to each other or to others outside the subgroup via call transfer.

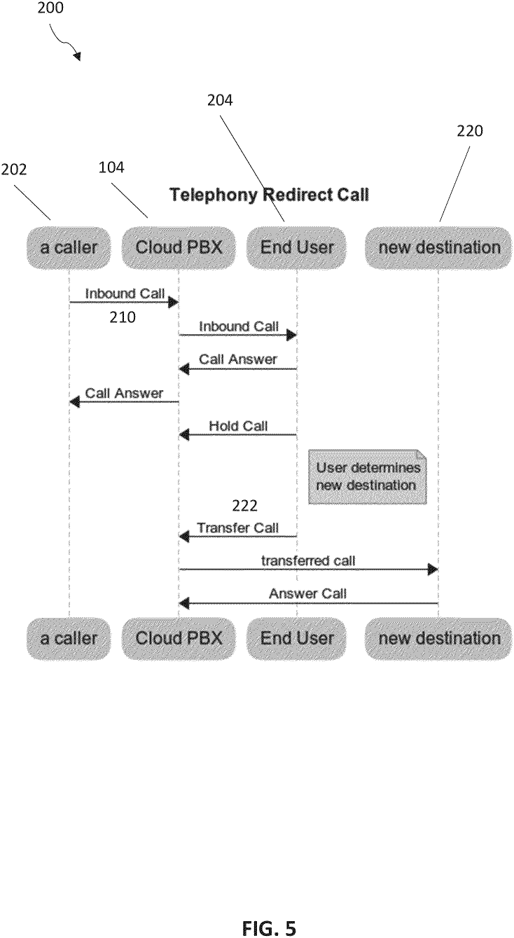

FIG. 5 illustrates another instance of call redirection for a standard telephone presentation system 200. A caller 202, places an inbound call 210 which is received by a cloud PBX 104. The inbound call 210 is sent on to an end user 204, who answers the call and is connected via the cloud PBX 104 to the caller 202. The end user 204 determines that the caller 202 needs to be sent to a new destination 220 and initiates a call transfer 222. The inbound call 210 is then re-routed to another end user.

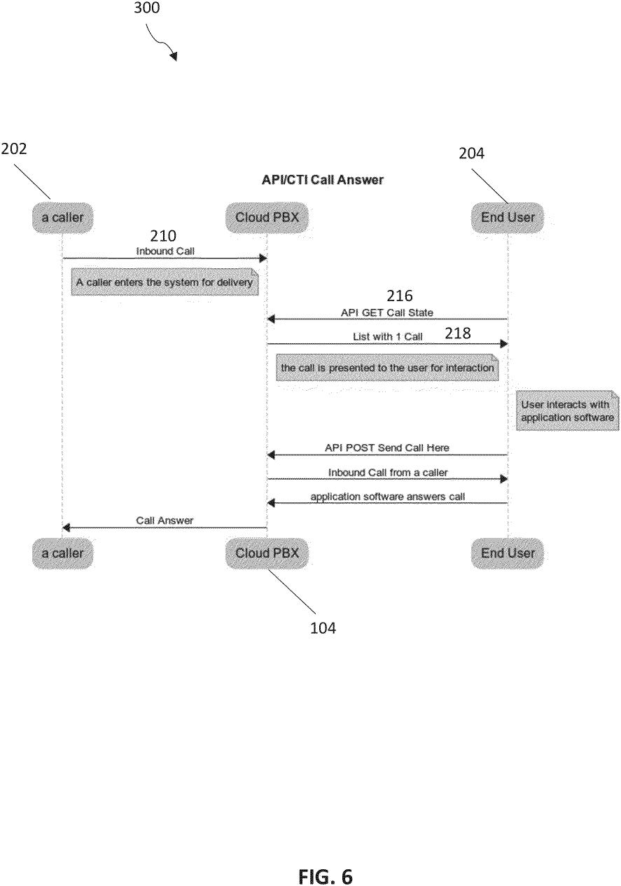

FIG. 6 illustrates another embodiment of the API/CTI telephone presentation system 300. A caller 202 has made an inbound call 210 to an end user 204. In this instance the initial end user 204 who received the call is not the intended recipient. This inadvertent end user 204 would like to transfer the call to the intended end user (not shown). In a traditional telephony protocol scenario, the exchange is seen in FIG. 5. In this API/CTI system, unlike in the traditional system, the end user 204 may query the cloud PBX 104 on some schedule, at step 216 to receive the list of incoming calls 218. The inadvertent end user 204 may then transfer the call to someone else (“API POST Send Call Here”). All of the call redirect is done by the client via a protocol exchange (or by the cloud PBX 104) and the end destination user 204 receives the transfer no matter the situation at the end destination.

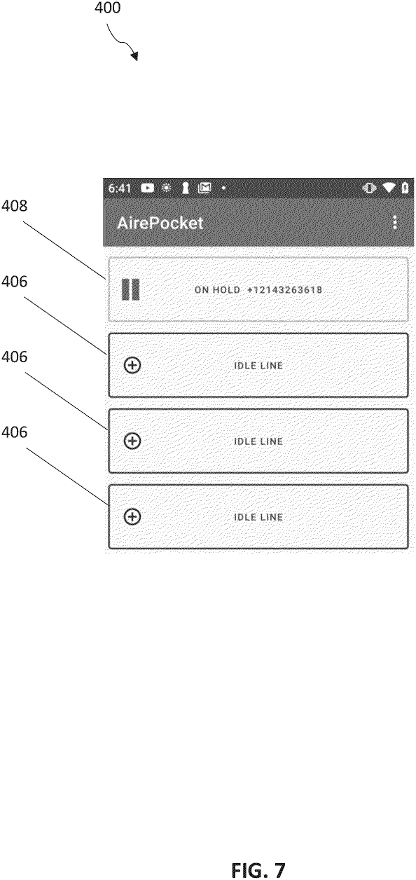

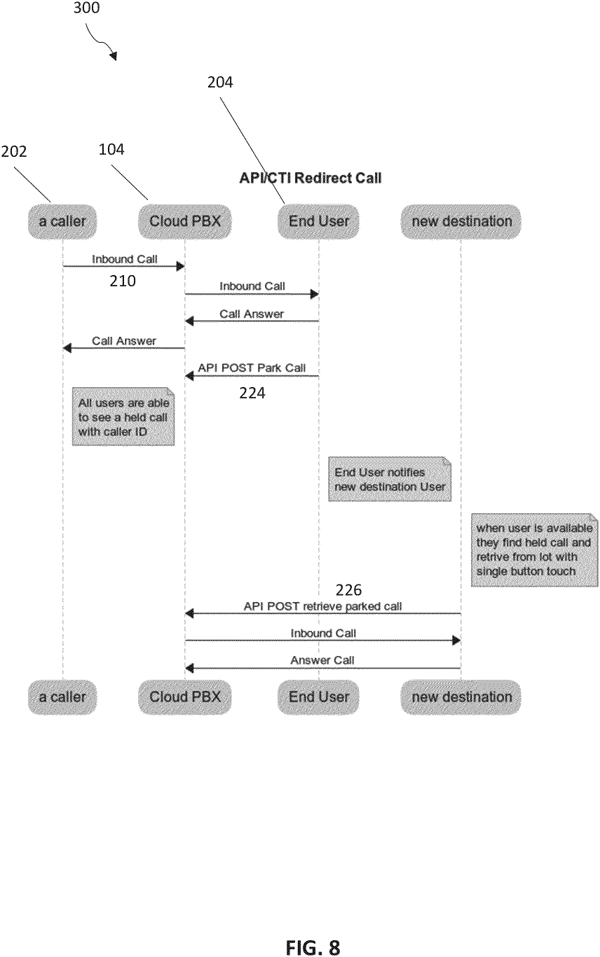

FIGS. 7 and 8 illustrate an alternative response for the API/CTI telephone presentation system 300. Rather than push a transfer to the far destination, a friendlier and more convenient way to get a call to its intended destination is to put the call on a common hold seen by all parties in the calling group and notify the user, by other means that they have a call waiting on them (e.g. voice through air “Hey, Jane, call for you on line 1”, SMS: “VIP on line 1. Pick up ASAP!!”, rapping on an office door, etc.). In this fashion, if the destination recipient is engaged in other business, they can conclude that business before engaging in the next activity waiting on them. The system may even include its own messaging service to enable users to communicate.

FIG. 7 illustrates a screenshot 400 with one call on hold. The API/CTI call presentation system 300 may display several lines of incoming calls including several idle lines 406 and, in this example, an incoming call on hold 408. In this example, the line on hold 408 also displays information associated with the incoming call, such as the telephone number of the caller 202. When an end user 204 is ready, the user 204 can look at the application software display 400, see the inbound caller identifier (e.g. “incoming call from 214-326-3618”) of the call which is waiting on hold 408 and the user 204 may retrieve that call. The display 400 and the application 300 provide a common hold location for all users in the call group. This brings up the fact that any user in the call group is able to retrieve this call in the same fashion equally well with one touch and without confusion as to which user of the call group has answered the call.

Using the API/CTI model, the mobile device may send a signal to the PBX to initiate the transfer which makes the PBX rather than the client the responsible party for the transfer activity. Because an API may be used for this interaction, the work of initiating a transfer can be made easier by offering the user a set of commonly transferred destinations. This eases the burden of initiating transfer and increases end user productivity.

FIG. 8 illustrates the API/CTI telephone call presentation system 300 with a call being redirected. A caller 202 initiates an inbound call 210 which is received by the cloud PBX 104. The end user 204 is notified of the inbound call and may answer the call. The API may place an incoming call 210 into a parking lot or waiting area 224. If the intended destination is outside of the calling group, a held call may not appear on the intended user’s screen as available for picking up. In such an instance the held call may not be retrievable by the intended recipient without intervention. Because of this, a transfer can be initiated which will send the call via transfer. The original end user 204 may notify the intended recipient of the call. The intended recipient may then request to the API to retrieve the parked call at step 226. The API/CTI would then connect the incoming call 210 with the intended end user.

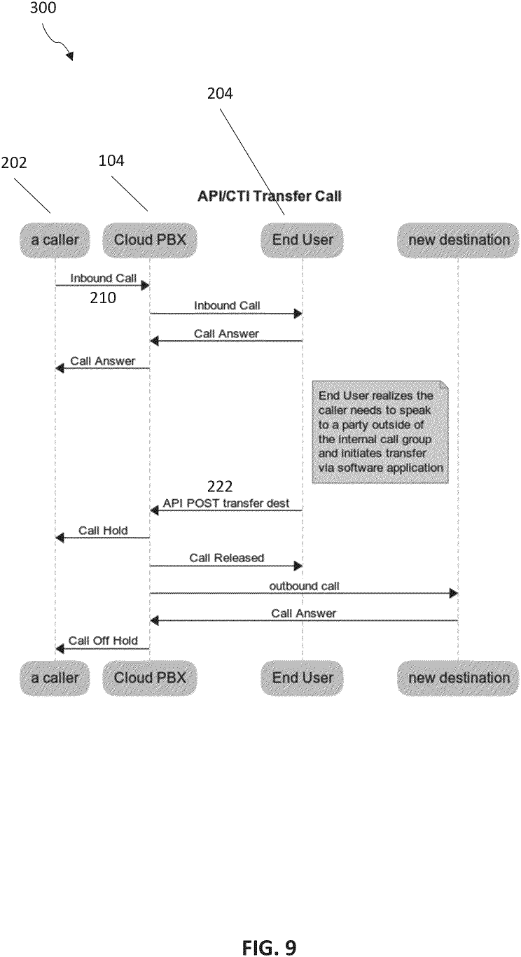

FIG. 9 illustrates an API/CTI transfer call for the API/CTI telephone presentation system analogous to the parking lot illustrated in FIG. 8. The initial end user 204 may realize they know to whom the inbound call 210 should be transferred and so may initiate the call transfer 222 directly.

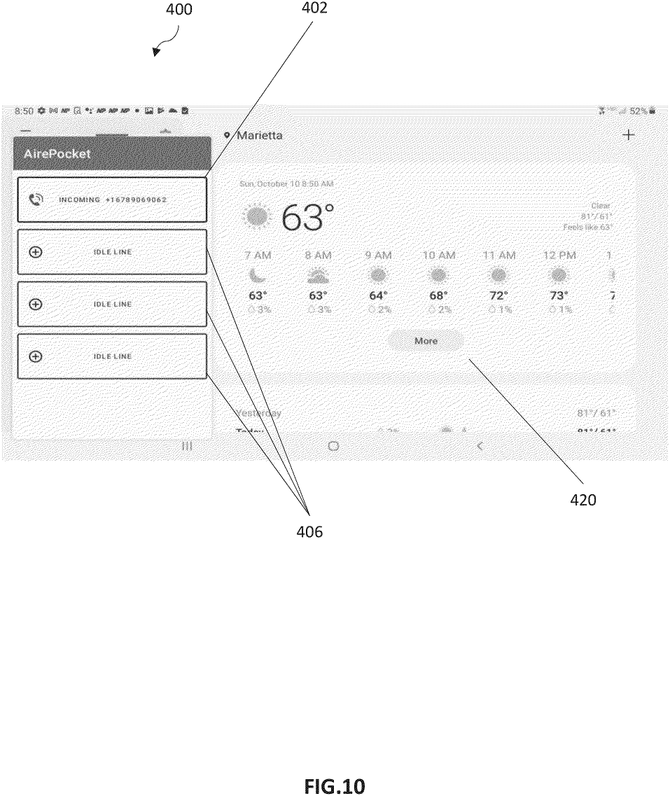

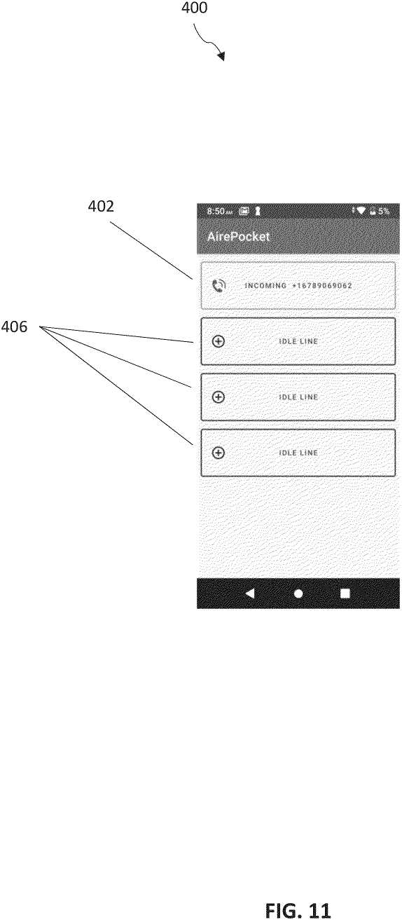

FIG. 10 illustrates a screen shot 400 of the telephone call presentation application 300 operating on a tablet with other applications 420 also running at the same time. An incoming call 402 and several idle lines 406 are also displayed. FIG. 11 illustrates a screen shot of the same incoming call 402 as in FIG. 10, but to a mobile phone. The application 400 also may display the other idle lines 406 which are available for other uses. In the example illustrated by these two figures, the same incoming call 402 being addressed to both devices simultaneously.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for displaying and interacting with multiple telephone lines comprising:
a server;
a personal user device;
a communication network;
software code residing on the server to enable a method comprising:
receiving, at the server, an initial request for telephonic communication;
displaying, at the personal user device, a notification of the initial request for telephonic communication; and
upon a user-initiated request, connecting the initial request for telephonic communication with the personal user device.

2. The system of claim 1, wherein the notification comprises information associated with a device which is the origin of the initial request.

3. The system of claim 1, wherein the method further comprises:
placing the initial request for telephonic communication in a waiting queue until the user initiates a request to connect.

4. The system of claim 1, wherein the method further comprises:
transferring the initial request for telephonic communication to a second user for connection.

5. The system of claim 1, wherein a plurality of additional initial requests for telephonic communication are also displayed on the personal user device and wherein the user may select from the plurality of initial requests to connect which initial request to accept.

6. The system of claim 1, wherein the server acts as a virtual private branch exchange.

7. The system of claim 1, wherein the method further comprises:
placing an initial request for telephonic communication on hold;
re-establishing a connection with an initial request for telephonic communication; and
placing an initial request for telephonic communication into a conference call with a plurality of personal user devices.

8. A method for displaying and interacting with multiple telephone lines comprising:
receiving, at a server, an initial request for telephonic communication;
displaying, at a personal user device, a notification of the initial request for telephonic communication; and
upon a user-initiated request, connecting the initial request for telephonic communication with the personal user device.

9. The method of claim 8, wherein the notification comprises information associated with a device which is the origin of the initial request.

10. The method of claim 8, further comprising:
placing the initial request for telephonic communication in a waiting queue until the user initiates a request to connect.

11. The method of claim 8, further comprising:
transferring the initial request for telephonic communication to a second user for connection.

12. The method of claim 8, wherein a plurality of additional initial requests for telephonic communication are also displayed on the personal user device and wherein the user may select from the plurality of initial requests to connect which initial request to accept.

13. The method of claim 8, wherein the server acts as a virtual private branch exchange.

14. The method of claim 8, further comprising:
placing an initial request for telephonic communication on hold;
re-establishing a connection with an initial request for telephonic communication; and
placing an initial request for telephonic communication into a conference call with a plurality of personal user devices.
